(19) United States
(12) Patent Application Publication
(10) Pub. No.: US 2010/0128973 A1
(43) Pub. Date: May 27, 2010

(54) Stereo image processing apparatus, stereo image processing method and computer-readable recording medium

(75) Inventors: Toshiyuki Kamiya, Osaka (JP); Hiroyuki Yagyuu, Osaka (JP); Hirokazu Koizumi, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC SYSTEM TECHNOLOGIES, LTD., Osaka (JP)

(21) Appl. No.: 12/292,765

(22) Filed: Nov. 25, 2008

(51) Int. Cl. G06K 9/00

(52) U.S. Cl. 382/154

(57) ABSTRACT

A stereo image processing apparatus 1 specifies a line pair having a high correlation between one image and the other image of a stereo image, for an image region which has a predetermined width and is parallel to a scanning direction (X direction) in a stereo image which shoots a predetermined region from two different positions and has a scanning line direction and an epipolar line direction matched with each other, obtains a shift (vertical azimuth difference) in a vertical direction (Y direction) between the one image and the other image of the stereo image according to each position of the specified line pair, and corrects the stereo image so as to eliminate the obtained shift.

### BACKGROUND OF THE INVENTION

1. Field of the Invention

The present invention relates to a stereo image processing apparatus, a stereo image processing method, and a computer-readable recording medium.

2. Description of the Related Art

There is widely applied a method of generating three-dimensional data representing land features (DEM (Digital Elevation Map) data) by stereo matching, using an image obtained from a satellite, an airplane, or the like.

Here, the stereo matching processing is processing of two images shot from different viewpoints, so-called a stereo image, for obtaining a corresponding point in each of the images shooting the same point and obtaining a depth to an object or a shape by the triangulation principle using an azimuth difference thereof.

Various methods have already been proposed for this stereo matching processing. For example, Unexamined Japanese Patent Application KOKAI Publication No. H3-167678 discloses a method using the area correlation method which is widely used commonly. This area correlation method is a method which sets a correlation window in the left image for a template, moves a search window in the right image to calculate a cross-correlation coefficient with the template, assumes the cross-correlation coefficient to be a matching degree, and obtains the corresponding point by searching for the high matching degree.

In the above method, it is possible to obtain a positional shift length of the corresponding point in the right image, that is, the azimuth difference, for each point in the left image by limiting a moving range of the search window to a direction of an epipolar line in the image for reducing the processing amount. Here, the epipolar line is a straight line which can be drawn as an existing range of a point in one image, the point corresponding to a certain point in the other image of the stereo image. The epipolar line is described in “Image Analysis Handbook” (edited by Mikio Takagi and Haruhisa Shimoda, University of Tokyo Press, January 1991, pp. 597-599), for example.

Usually, the epipolar line direction is different from a scanning line direction of the stereo image. However, it is possible to make the epipolar line direction to match the scanning line direction of the stereo image for performing rearrangement, by carrying out coordinate conversion. This coordinate conversion method is described in the above “Image Analysis Handbook”.

In the stereo image provided with the rearrangement as described above, since the moving range of the search window for the corresponding point can be limited onto the scanning line (epipolar line), y-coordinates of the corresponding points in the right and left images match each other and the azimuth difference can be expressed only by an x-coordinate difference between the corresponding points in the right and left images.

However, there is a concern that a vertical shift is caused between the corresponding points in the right and left images of the stereo image by camera shake in the stereo image shooting, even when the coordinate conversion processing is carried out to match the epipolar line direction with the image scanning line direction.

### SUMMARY OF THE INVENTION

The present invention has been achieved in view of the above situation and aims at providing a stereo image processing apparatus or the like which can correct the vertical shift in the stereo image.

For achieving the above purpose, a stereo image processing apparatus according to a first aspect of the present invention includes:

a stereo image data acquiring section acquiring image data of a stereo image of a predetermined region shot from two different positions and has a scanning line direction and an epipolar line direction approximately matched with each other;

a line specifying section specifying a line pair which has a high correlation between one image and the other image of the stereo image, for an image region which has a predetermined width and is parallel to the scanning line direction of the stereo image;

a shift obtaining section obtaining a shift between the one image and the other image of the stereo image according to each position of the line pair specified by the line specifying section; and

an image correcting section correcting the stereo image so as to eliminate the shift obtained by the shift obtaining section.

A stereo image processing method according to a second aspect of the present invention includes:

a stereo image data acquiring step of acquiring image data of a stereo image of a predetermined region shot from two different positions;

a line specifying step of specifying a line pair which has a high correlation between one image and the other image of the stereo image, for an image region which has a predetermined width and is parallel to the scanning line direction of the stereo image;

a shift obtaining step of obtaining a shift between the one image and the other image of the stereo image according to each position of the line pair specified in the line specifying step; and

an image correcting step of correcting the stereo image so as to eliminate the shift obtained in the shift obtaining step.

A computer-readable recording medium recording therein a program for causing a computer to function as:

a stereo image data acquiring section acquiring image data of a stereo image of a predetermined region shot from two different positions and has a scanning line direction and an epipolar line direction approximately matched with each other;

a line specifying section specifying a line pair which has a high correlation between one image and the other image of the stereo image, for an image region which has a predetermined width and is parallel to the scanning line direction of the stereo image;

a shift obtaining section obtaining a shift between the one image and the other image of the stereo image according to each position of the line pair specified by the line specifying section; and

an image correcting section correcting the stereo image so as to eliminate the shift obtained by the shift obtaining section.

### BRIEF DESCRIPTION OF THE DRAWINGS

These objects and other objects and advantages of the present invention will become more apparent from the following detailed description and the accompanying drawings in which:

FIG. 1 is a block diagram showing an internal configuration of a stereo image processing apparatus;

FIG. 2 is a diagram showing an example of parameters stored in a storage section;

FIG. 3 is a flowchart showing an example of operation in vertical azimuth difference correction processing;

FIG. 4 is a diagram showing an example of a stereo image;

FIG. 5 is a diagram for illustrating processing for specifying a line pair which has a high correlation between the left image and the right image of the stereo image; and

FIG. 6 is a diagram for illustrating processing for specifying a line pair which has a high correlation between the right image and the left image of the stereo image.

### DETAILED DESCRIPTION OF THE PREFERRED EMBODIMENT

Hereinafter, a stereo image processing apparatus 1 according to an embodiment of the present invention will be described. The stereo image processing apparatus 1 is an apparatus correcting a position shift between right and left images for an image (stereo image) composed of the right image and the left image of the same region shot from different right and left positions, respectively.

Note that this stereo image is an image which is subjected to rearrangement (parallel arrangement) such that an epipolar line direction and an image scanning line direction match each other by a method described in “Image Analysis Handbook” (edited by Mikio Takagi and Haruhisa Shimoda, University of Tokyo Press, January 1991, pp. 597-599), for example. That is, y-coordinates of corresponding points in the right image and left image match each other to some extent.

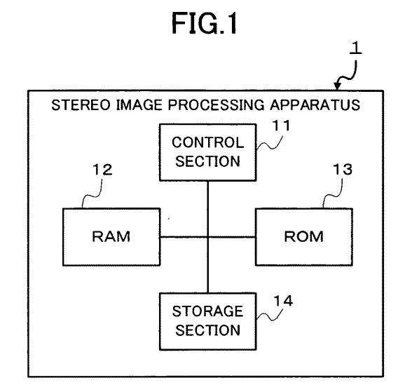

The stereo image processing apparatus 1 includes a control section 11, a RAM 12, a ROM 13, and a storage section 14, as shown in FIG. 1.

The control section 11, which is configured with a CPU (Central Processing Unit) and the like, performs predetermined processing according to a program stored in the ROM 13 or the storage section 14 and controls the entire stereo image processing apparatus 1.

For example, the control section 11 determines scanning lines having the highest correlation between the right image and the left image of the stereo image, and, when a shift (vertical azimuth difference) exists between the vertical positions (Y coordinates) of the scanning lines which have been determined to have the highest correlation with each other, the control section 11 performs vertical azimuth difference correction processing to correct this shift. Note that details of the vertical azimuth difference correction processing will be described hereinafter.

The RAM (Random Access Memory) 12 is a volatile memory which functions as a work memory storing a program read out by the control section 11 to perform the predetermined processing and storing necessary data for the control section 11 to execute the program.

The ROM (Read Only Memory) 13 is a non-volatile memory preliminarily storing a program, fixed data, or the like, for the control section 11 to perform the predetermined processing. The control section 11 reads out the program or the like from the ROM 13 as needed, develops the program or the like into the RAM 12, and performs the predetermined processing according to the program or the like.

The storage section 14 is configured with a storage unit such as a hard disk drive or the like and stores various kinds of information. For example, the storage section 14 stores the stereo image that becomes a target of the vertical azimuth difference correction processing.

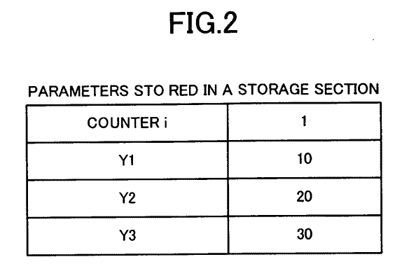

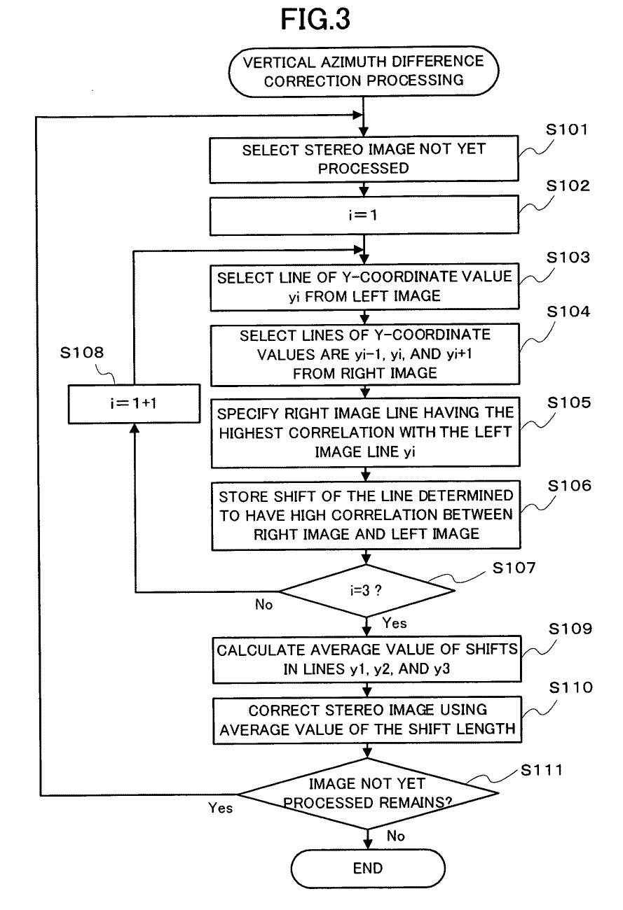

Further, the storage section 14 stores various kinds of parameters as shown in FIG. 2, which are used in the vertical azimuth difference correction processing to be described hereinafter.

A counter i is a counter utilized in the vertical azimuth difference correction processing.

In y1, y2, and y3, the y-coordinate values are set for the lines which are compared with each other for the correlation between the right image and the left image in the vertical azimuth difference correction processing.

Note that the stereo image processing apparatus 1 can be configured using a computer or the like which is widely used commonly.

Next the operation of the vertical azimuth difference correction processing will be described.

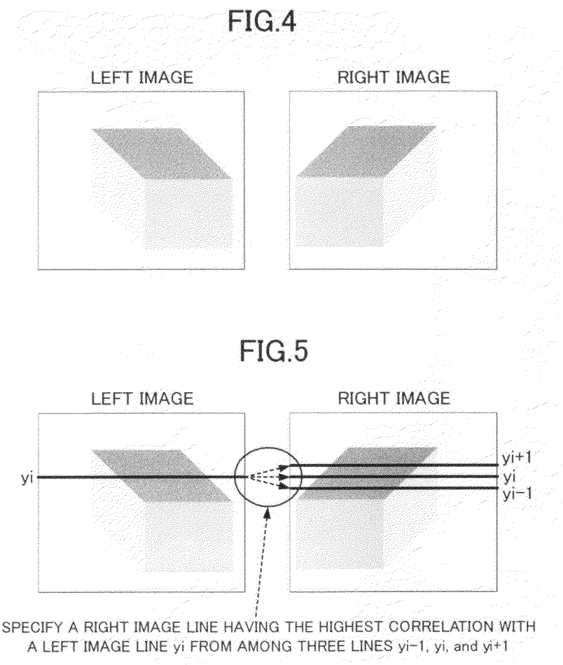

First, the control section 11 selects the stereo image not yet processed, that is, one pair of the right image and the left image as shown in FIG. 4, from the storage section 14 (Step S101).

Subsequently, the control section 11 initializes the value of the counter i to be one (Step S102).

Then, the control section 11 selects a pixel group (line) where the y-coordinate value is yi from the left image (Step S 103). Note that this line may also be a pixel group having a height of several pixels in the y direction.

Then the control section 11 selects three lines in total; a line y1 and lines ±1 pixel apart from y1, from the right image (Step S103). That is, three lines where the y-coordinate values are yi−1, yi, and yi+1, in the order from the bottom, are selected from the right image by this processing (Step S104).

Subsequently, the control section 11 calculates the correlation of the left image line yi selected in Step S102 with each of the right image lines yi−1, yi, and yi+1 selected in Step 5103, and specifies the right image line which has the highest correlation with the left image line yi as shown in FIG. 5 (Step S105).

This processing in Step S105 may be performed specifically as follows.

First, the control section 11 obtains each pixel of the right image corresponding to each pixel composing the left image line yi, using a method such as one described in Unexamined Japanese Patent Application KOKAI Publication No. H4-299474. Then, the control section 11 may specify any one of lines among yi−1, yi, and yi+1 that matches most with each of the obtained pixel position in the right image as the right image line having the highest correlation.

Note that the processing of Step S105 is not limited to the above described example, and may utilize another matching method, if the line having the highest correlation can be specified.

Subsequently, the control section 11 stores a positional shift length between the left image line and the right image line specified to have the high correlation in Step S105, into the storage section 14 (Step S106).

For example, when Step S105 specifies the right image line yi to have the highest correlation with the left image line yi, no-line-shift (shift length: 0) is stored. Further, when Step S105 specifies the right image line yi+1 to have the highest correlation with the left image line yi, it is stored that the right image shifts upward (Y-axis positive direction) against the left image by one pixel.

Then, the control section 11 determines whether the value of the counter i is three or not (Step S107). If the value of the counter i is determined not to be three (No in Step S107), the control section 11 increments the counter i by one (Step S108), and repeats the processing of Steps S103 to S107. That is, the vertical shift between the right image and the left image is calculated and stored for another position yi.

If the value of the counter i is determined to be three (Yes in Step S107), the control section 11 obtains an average value of the shift lengths stored in Step S106 (i.e., respective shift lengths in y1, y2, and y3) (Step S109). Note that the control section 11, after finishing this processing, erases (resets) the information representing the shift lengths, which is stored in Step S106 and is not used afterward.

Subsequently, the control section 11 corrects the stereo image (right image and left image) using the average value of the shift length obtained in Step S109 (Step S110). For example, when the average value of the shift length obtained in Step S109 indicates that the right image shifts upward by two pixels, the whole right image is moved downward by two pixels (two is subtracted from the y-coordinate values of the whole right image). Note that, inversely, the whole left image also may be moved upward by two pixels (two is added to the y-coordinates of the whole left image).

Subsequently, the control section 11 determines whether the stereo image not yet processed (not yet selected) remains or not (Step S111).

If the stereo image not yet processed (not yet selected) is determined to remain (Yes in Step S111), the control section 11 moves the process to Step S101, and repeats the processing to correct the shift between the right image and the left image for the stereo image not yet processed (Steps S101 to S110).

If the stereo image not yet processed (not yet selected) is determined not to remain (No in Step S111), the control section 11 finishes the vertical azimuth difference correction processing.

In this manner, the present embodiment checks the correlation of the both images in the neighborhood of the corresponding position (yi) for the stereo image which is subjected to the parallel arrangement, and obtains the line shift. Then, the present embodiment corrects the vertical position of the stereo image so as to eliminate the obtained line shift. Accordingly, it is possible to correct the vertical shift of the stereo image.

Note that the present invention can be variously applied and modified.

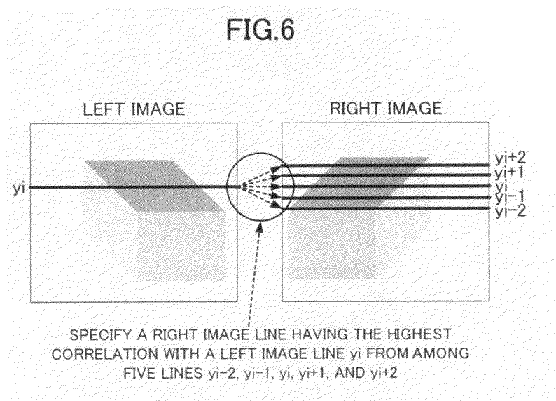

For example, the present embodiment specifies the line having the highest correlation with the left image line yi of the three right image lines yi−1, yi, and yi+1 in Step S106. However, the present embodiment is not limited to this example, for example the line having the highest correlation may be specified from among the five right image lines yi−2, yi−1, yi, yi+1, and yi+2, as shown in FIG. 6. In conclusion, the right image lines for specifying the line having the high correlation with the left image line yi may include yi and any lines near yi.

Further, the present embodiment obtains and records the shift lengths of the three lines y1, y2, and y3 between the right and left images (Step S106) and obtains the average value thereof (Step S109). However, the number of lines, for which the shift lengths are obtained and recorded, also may be three or more or less than three and may be optional.

Moreover, the present embodiment is described in an assumption that the stereo image is composed of the right image and the left image which are shot from right and left, respectively, but the present invention is not limited to this assumption and can be applied to the stereo image of the same region shot from different positions.

The above hardware configuration or flowchart is one example, and can be changed or modified optionally.

The central parts carrying out the processing in the stereo image processing apparatus 1, which is configured with the control section 11, the RAM 12, the ROM 13, the storage section 14, etc., can be realized by using a common computer system without using the dedicated system. For example, it is also possible to configure the stereo image processing apparatus 1 performing the above processing by storing a computer program, which is used for performing the above operation, into a computer-readable recording medium (flexible disk, CD-ROM, DVD-ROM, etc.) for distribution and by installing the computer program into the computer. Further, it is also possible to configure the stereo image processing apparatus 1 by storing the computer program in a storage unit of a server on a communication network such as the Internet and by downloading the computer program into the common computer system, etc.

Further, when the function of the stereo image processing apparatus 1 is realized by task sharing of an OS (Operating System) and an application program, or collaboration of the OS and the application program, only the part of the application program may be stored in the recording medium or the storage unit.

Moreover, it is also possible to superimpose the computer program on a carrier wave and distribute the computer program via the communication network. For example, the computer program may be posted on a BBS (Bulletin Board System) on the communication network and the computer program may be distributed via the network. Accordingly, the above processing can be carried out by a configuration to activate this computer program and to execute the computer program in the same manner as another application program under the control of the OS.

1. A stereo image processing apparatus, comprising:
a stereo image data acquiring section acquiring image data of a stereo image of a predetermined region shot from two different positions and has a scanning line direction and an epipolar line direction approximately matched with each other;
a line specifying section specifying a line pair which has a high correlation between one image and the other image of the stereo image, for an image region which has a predetermined width and is parallel to the scanning line direction of the stereo image;
a shift obtaining section obtaining a shift between the one image and the other image of the stereo image according to each position of the line pair specified by the line specifying section; and
an image correcting section correcting the stereo image so as to eliminate the shift obtained by the shift obtaining section.

2. The stereo image processing apparatus according to claim 1, wherein,
the line specifying section, from among a plurality of lines in the other image of the stereo image corresponding to a neighboring position of a line in the one image of the stereo image, specifies the line having the highest correlation with the line as a pair having the high correlation with the line.

3. The stereo image processing apparatus according to claim 1, wherein
the line specifying section, regarding a plurality of the image regions which have the predetermined widths and are parallel to the scanning line direction of the stereo image, specifies the line pair having the high correlation for each of the image regions, and
the shift obtaining section, for each of the line pairs specified by the line specifying section, obtains the shift according to each position of the line pair and obtains an average value of the obtained plurality of shifts as the shift between the one image and the other image of the stereo image.

4. A stereo image processing method, comprising:
a stereo image data acquiring comprising acquiring image data of a stereo image of a predetermined region shot from two different positions;
a line specifying comprising specifying a line pair which has a high correlation between one image and the other image of the stereo image, for an image region which has a predetermined width and is parallel to a scanning line direction of the stereo image;
shift obtaining comprising obtaining a shift between the one image and the other image of the stereo image according to each position of the line pair specified in the line specifying; and
image correcting comprising correcting the stereo image so as to eliminate the shift obtained in the shift obtaining.

5. The stereo image processing method according to claim 4, wherein,
the line specifying, from among a plurality of lines in the other image of the stereo image corresponding to a neighboring position of a line in the one image of the stereo image, specifies the line having the highest correlation with the line as a pair having the high correlation with the line.

6. The stereo image processing method according to claim 4, wherein
the line specifying, regarding a plurality of the image regions which have the predetermined widths and are parallel to the scanning line direction of the stereo image, specifies the line pair having the high correlation for each of the image regions, and
the shift obtaining obtains the shift according to each position of the line pair for each of the line pairs specified in the line specifying, and obtains an average value of the obtained plurality of shifts as the shift between the one image and the other image of the stereo image.

7. A computer-readable recording medium recording therein a program for causing a computer to function as:
a stereo image data acquiring section acquiring image data of a stereo image of a predetermined region shot from two different positions and has a scanning line direction and an epipolar line direction approximately matched with each other;
a line specifying section specifying a line pair which has a high correlation between one image and the other image of the stereo image, for an image region which has a predetermined width and is parallel to the scanning line direction of the stereo image;
a shift obtaining section obtaining a shift between the one image and the other image of the stereo image according to each position of the line pair specified by the line specifying section; and
an image correcting section correcting the stereo image so as to eliminate the shift obtained by the shift obtaining section.

8. The stereo image processing apparatus according to claim 2, wherein
the line specifying section, regarding a plurality of the image regions which have the predetermined widths and are parallel to the scanning line direction of the stereo image, specifies the line pair having the high correlation for each of the image regions, and
the shift obtaining section, for each of the line pairs specified by the line specifying section, obtains the shift according to each position of the line pair and obtains an average value of the obtained plurality of shifts as the shift between the one image and the other image of the stereo image.

9. The stereo image processing method according to claim 5, wherein
the line specifying, regarding a plurality of the image regions which have the predetermined widths and are parallel to the scanning line direction of the stereo image, specifies the line pair having the high correlation for each of the image regions, and
the shift obtaining obtains the shift according to each position of the line pair for each of the line pairs specified in the line specifying, and obtains an average value of the obtained plurality of shifts as the shift between the one image and the other image of the stereo image.
